(19) United States
(12) Patent Application Publication
(10) Pub. No.: US 2014/0307286 A1
(43) Pub. Date: Oct. 16, 2014

(54) DRIVER-BASED PRINT PREVIEW, REDUCED SIZE PROOFING, AND VIRTUAL PRINTING OF DOCUMENTS

(71) Applicant: XEROX CORPORATION, Norwalk, CT (US)

(72) Inventor: Trevor J. Snyder, Newberg, OR (US)

(73) Assignee: XEROX CORPORATION, Norwalk, CT (US)

(21) Appl. No.: 13/863,276

(22) Filed: Apr. 15, 2013

(51) Int. Cl. G06F 3/12

(52) U.S. Cl. CPC G06F 3/1208; G06F 3/1285
USPC 358/1.15

(57) ABSTRACT

The disclosed virtual printing and print preview systems and methods allow users to preview and proof a specialty print job on their in-house printers or computers. The printing systems and methods can be in the form of software, such as a printer driver, installed on a user's in-house printer or computer. The software allows the user to virtually print to other remote printing devices while preparing, previewing, and customizing the specialty print job on the user's in-house device.

### BACKGROUND

Most individuals and businesses have printing needs in some capacity and select a printer based on their core needs. The selected printers usually meet the core printing needs of the individuals and businesses, but are not equipped for specialized projects or unique printing requirements. When the need arises to print a special project or unique printing requirement, the individuals and businesses are unable to use their selected printer and are required to seek help from a third party, such as a print shop, to complete the project. Working with a print shop on a printing project can be time-consuming and inefficient and can reduce the ability to control the quality of the print job.

For example, a business owns a multi-function printer (MFP) for its usual printing needs. Occasionally, the business needs to print on a media that is larger or smaller than the media on which the MFP can print or needs to print on a specialty media like a thick or glossy media. Also, the business may need a very large print job that would be cost-prohibitive or impractical to complete on its MFP. The business must engage with an outside printing service to complete the print job. Engaging an outside printing service can have a significant learning curve and can be inefficient, especially for infrequent and diverse special print jobs like posters, banners, etc.

For example, it typically takes time to locate the appropriate printing business and determine the address and capability. Also, a business must physically send a representative to the print shop several times. The business may experience significant time delays for the print shop service and poor quality proofing methods that reduce the business' certainty of the quality of the final product. While the learning curve improves with more frequent usage of print shop services, most businesses or individuals do not require a high volume of specialty print jobs and never significantly improve their print shop experience. The end result for businesses with specialty printing needs that engage a printing service is time-consuming, inefficient, and can be frustrating. Embodiments of the invention address these and other limitations of the currently available systems.

### BRIEF DESCRIPTION OF THE DRAWINGS

FIG. 1 is an example computing system in which the disclosure can operate.

FIG. 2 shows an example operating environment of the disclosure.

FIG. 3a is an input printing device with a display and an example virtual print screen image.

FIG. 3b is another example of an input printing device with a display and an example virtual print screen image.

FIG. 4 is another example virtual print screen image.

FIG. 5 is an example sizing screen image.

FIGS. 6a and 6b show an example print preview screen images.

### DETAILED DESCRIPTION

The following description of the disclosed printing methods and systems includes the following terms with their associated definitions, as used herein. Printing selection data is data related to a printing selection of the user and can include selecting a printer, a print type (e.g., large media, high volume, special color quality, etc.), or anything else relating to the printing needs of the user. The user is any person, computer, or other entity engaging in the printing process. The input printing device is any suitable device at which the user engages in the printing process. For example, the input printing device includes the user's printer, computer, tablet, smartphone or the like. The input element of the input printing device is any suitable tool that receives input from the user and can include a display, such as a touchscreen or a screen with a keyboard, a microphone and speaker, a selection tool like a mouse, wand, or other tool, and any other suitable elements that are used to input data into the printing system.

The output printing device is the device that prints the print job, such as a remote printer with special printing capabilities. The user can specifically request the output printing device or the printing method can select the output printing device based on the user's printing selections. Printing capabilities are the features or functions that the printer is able to perform and includes the type of paper or media on which the printer can print, the quality of color and image, the availability to bind or fold the print job, the ability to efficiently print in high volume, and any other function or feature of the printer. Both the input printing device and the output printing device have respective printing capabilities. The printing capabilities of the input printing device are sometimes different than the printing capabilities on the output printing device.

The disclosed printing methods and systems relate to virtual printing and print preview functionality. A user's printer, such as a MFP, can include software, like a printer driver, that allows the user to print to other printers and preview proofs of the print jobs directly from the user's printer. Users oftentimes have access to printers that meet most of their usual needs. Special projects, large quantity projects, and other unique printing needs arise for users from time to time that the users' printers are unable to provide. For example, large quantity print jobs take a long time to print or cost too much to print on a user's printer. In another example, the user may wish to print to a media that is unsupported by the user's printer. In yet another example, the user may wish to print to a higher quality printer or with color options that are not available on the user's printer. In another example, the user may wish to have special binding or folding of the print job that is not practical or possible for the user's printer to do.

The disclosed printing methods and systems disclose software and computing systems that allow a user to control the printing of special projects directly from user's printer, regardless of whether the user's printer has the capability to print the desired project. In some examples, printer driver software is installed on the user's printer that permits the user to print to several other printers with printing capabilities that are different from the printing capabilities of the user's printer. The user can control the quantity, quality, color, media, and other printing qualities of the printing job directly from the user's printer and without engaging a third party vendor, such as a print shop, to create the print job. Because the user can create special print jobs in real-time and directly on his/her printer's user interface, the time needed to create a print job and the efficiency of the special print job process improve over engaging a print shop directly. The user is able to “virtually” print to other remote printers from the user's printer.

The disclosed printing methods and systems also disclose software and computing systems that present a print preview of the user's special print job. The print preview can be in the form of a visual on-screen proof that is displayed for the user on the user's print driver or can be an actual printed proof from the printer itself. The displayed proof is presented in the same manner as the final printed product. For example, while the user's printer does not have the exact printing capabilities for the specialty print job, it can simulate many of the attributes of the printer that will print the specialty print job, such as color, quality, and print technology of print required by the user's special print job. The user is able to preview the proof of the final printed product of the special print job on the user's computer monitor or in-house printer. The user can customize any feature of the special print job on the previewed proof on the in-house printer as well. The print preview and customization features of the disclosed printing methods and systems provide the user with real-time feedback during the special print job process.

### The Virtual Printing and Print Preview Process

The disclosed printing methods can include receiving printing selection data from a user at an input element of an input printing device. The input printing device can be the user's in-house printer or computer and can include any suitable user interface and input element, such as a touchscreen, keyboard, and the like. The printing selection data can include a printing selection that the user selects from a plurality of printing selections. The printing selection can be any one or combination of printing capabilities, including a specialty printing device, a specialty type of printing media or printing size, custom binding, custom or specialty quality color, cost per page for high quantity print jobs, and the like. In some examples, the user selects the printing selection by selecting a specific printing device. In other examples, the user selects the printing selection by selecting various qualities of the specialty print job.

The disclosed printing methods also include identifying at least one output printing device that is remote from the input printing device. The identification of the output printing device is based on the printing selection data received from the user. The output printing device can be physically remote from the input printing device. The output printing device can be manually identified by the user during the printing selection process, in some examples. In other example, the output printing device can be identified based on the printing capabilities of the user's specialty print job.

A data message is sent to the output printing device that includes the printing selection. The data message can be sent from the input printing device, such as the user's printer or computer, or any other device, such as a user's mobile device, tablet, personal computer, or the like. In some examples, in addition to being accessible directly on the user's in-house printer, the software can also be accessible by a user through a network, such as the Internet. The printing selection can be added to any other existing printing selection or can be saved for adding future additional printing selections to it.

In other examples, the input printing device is a printer, which is any device that is configured to mark on a substrate. The marking is any suitable marking and can include any type of ink, gel, toner, and the like. The substrate is any suitable substrate, such as paper, films, plastics, and any other suitable base material on which the marking is placed. The input printing device can be a printer such as an MFP and includes a user interface device or other input element that is physically or wirelessly connected to the printer. In this example, the user is able to virtually print to other remote printers from the user's in-house printer by interacting with printer driver software installed on the user's in-house printer. The user virtually prints to the remote printers through the in-house printer's user interface, e.g., a touchscreen, keyboard, and/or other display element.

In some examples, the output printing device (the device on which the specialty print job will ultimately print) is displayed on an output element of the user's input printing device, such as the screen of user's in-house printer or the user's computer monitor. The output element is any suitable display, such as a screen, and can be combined with the user input element, such as a touchscreen or a screen with a keyboard or other user control tool. The user can then select the desired printing device selection through the input element on the input printing device (e.g., the printing device selections are displayed on a touchscreen and the user selects the desired printing device selection by touching the image of the selected output printing device).

In some examples, the input printing device and the output printing device have one or more different printing capabilities. The different printing capabilities can include any one or more of different printing media, quality of printing, color of printing, quantity of the printed items, etc. Any different printing capabilities may be included. In some examples, the printing selection requires the different printing capabilities, such as a type of media to which the user's input printing device does not print. In other examples, the printing selection does not require the different printing capabilities, but the user wishes to print to the output printing device for other reasons, such as lower cost, efficiency, availability, etc.

A preview of a proof of the printing selection can be displayed for the user, in some examples. The preview can be displayed directly on a screen or other display attached to the user's input printing device. From this previewed proof, the user is able to customize any customizable features of the proof, such as font, size, orientation, color, quality of print, adjust margins, etc. The user can initiate a request to customize the previewed proof by using the input element of the input printing device.

The previewed proof can include a simulation of the printing selection as it will print on the output printing device, even if the input printing device does not support an output quality or feature(s) of the printing selection. The output quality can relate to any printing quality and may include any one or more of margins, color, quality of print, and size.

The simulated proof also can be printed on the user's input printing device with indicators that show the user the printing differences that will occur when the simulated proof is printed on the output printing device. For example, a hard copy of the simulated proof is printed on the user's in-house printer with visible borders showing output printing device margins. Other visual indicators can also be used to show the user the size of the simulated proof as it will print on the output printing device.

Any print job created by the user can be stored by the input printing device, such as in the device's internal memory or on any other accessible external memory. In some examples, users can store proofs of their print jobs in an electronic “shopping cart” style account for later ordering, modification, or any other use. Print jobs stored in the shopping cart can also be part of a large batch order of print jobs. A user can create a print job and requests that the output printing device print a small quantity or sample of the print job. When the user approves of the sample, the user can later go back to the shopping cart and print a larger quantity or a final product. The print job data can be stored on a remote server or memory, such as in the “cloud” or elsewhere online. The shopping cart can also be accessed by a device, such as a user's computer, phone, or tablet, which can bypass the printer driver and access the shopping cart directly.

The user may be able to pay for the print job directly from the user's input printing device. The display or output element of the user's input printing device prompts the user to enter payment methods or other payment information at any point during the ordering process. Further, the user is also prompted to select a delivery method for the printing selection in some examples. The delivery method can be any suitable method including courier, mail, pick-up, or the like.

In some examples, a determination is made regarding whether the input printing device is capable of printing the user's printing selection. If the input printing device can print the user's printing selection, another determination can be made regarding the cost efficiency of printing the printing selection on the input printing device and comparing that cost efficiency with the cost efficiency of printing the printing selection on any one or more of a remote or other output printing device. When the input printing device is not capable of printing the user's printing selection, one or more remote printing devices are identified that can print the user's printing selection. The user can then select the remote printing device on which to print the printing selection.

The above printing methods can be embodied in a computing environment that includes any desired user input element(s) to receive user input about the printing selection, a memory configured to store any information about the printing selection, a processor configured to perform any one or more of the actions discussed above, and a display or other output element that displays information to the user, as will be discussed more below.

The above printing methods can also be embodied in a printer driver installed on a computing device without a physical printer being present. The printer driver includes all of the same functionality as the printer itself, including previewing proofs of a specialty print job, ordering prints, etc.

### Virtual Printing and Print Preview Software Operating Environment

One way for users with printing needs to successfully print special projects includes software that is installed in the users' existing printer(s) that has the capability to virtually print a special project on a remote printing device that has the necessary printing capabilities. The software can be in the form of a printer driver installed on the users' printer(s). The user can prepare a special printing project with the same comfort and familiarity that they have with the printer(s) that is used for the user's routine printing needs.

The virtual printing and print preview software can be used in a variety of operating environments and relates to providing a user with the ability to print special printing jobs on remote printers from the user's printer. The user's printer can be connected to a network, such as the Internet, a private network, or any other connection, to one or more remote printers. The remote printers are defined as any printer other than the user's printer where the printer driver software is installed. The remote printer can be physically remote from the user's printer or in any other suitable location.

The software disclosed in this patent application relates to the user experience when operating the user's printer with the installed virtual printing and print preview software. The virtual printing and print preview software can be implemented using various computing devices and networks of devices and can include any one more of application-specific integrated circuits (ASICs), programmable computing device(s) that execute firmware or software instructions, or some combination of purpose-specific electronic circuitry and firmware or software instructions that are executed on a programmable computing device.

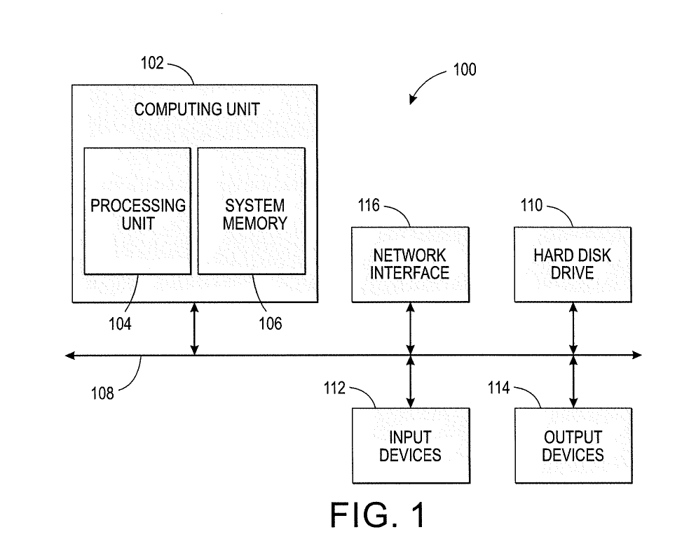

FIG. 1 shows an example computer 100 used to implement various embodiments of the printing methods and systems. The computer 100 has a computing unit 102 that includes a processing unit 104 and a system memory 106. The processing unit 104 is any type of processing device for executing software instructions, such as a conventional microprocessor. The system memory 106 is any suitable memory that stores software instructions for execution by the processing unit 104. The computing unit 102 can be included in the user's printer on which the printer driver software is installed.

The processing unit 104 and the system memory 106 are connected, either directly or indirectly, through a bus 108 or alternate communication structure to one or more peripheral devices, such as additional memory storage like hard disk drive 110 and/or a flash memory card. The processing unit 104 and the system memory 106 also may be directly or indirectly connected to one or more input devices 112 and one or more output devices 114. The input devices 112 can be any device for receiving input to the computer 100, such as a keyboard, touch screen remote control pad, pointing device, scanner, camera, or microphone. The input devices 112 can be a user interface of the user's printer that is either physically connected to the user's printer or is remote, by electronically connected to the user's printer, in any suitable manner. The output devices 114 can be any device for outputting information from the computer 100, such as an audio-visual display, printer, or the like.

The computing unit 102 is directly or indirectly connected to one or more network interfaces 116 for communicating with a network and translates data and control signals from the computing unit 102 into network messages according to one or more communication protocols. An interface 116 employs any suitable connection agent for connecting to a network, including for example, a wireless transceiver, a power line adapter, a modem, or an Ethernet connection. In some examples, the computing unit 102 is connected to a device that performs multiple functions, such as input, output, and storage functions, such as a tablet, smartphone, laptop computer or the like. The computer shown in FIG. 1 is merely an example computing environment and any other suitable computing environment can also be used.

Any one or more of the elements of the computer 100 can be physically located near or physically located remotely from any other element. Any one or more of the elements shown in FIG. 1 can be omitted or customized by the user.

### Examples of the Virtual Printing and Print Preview Software

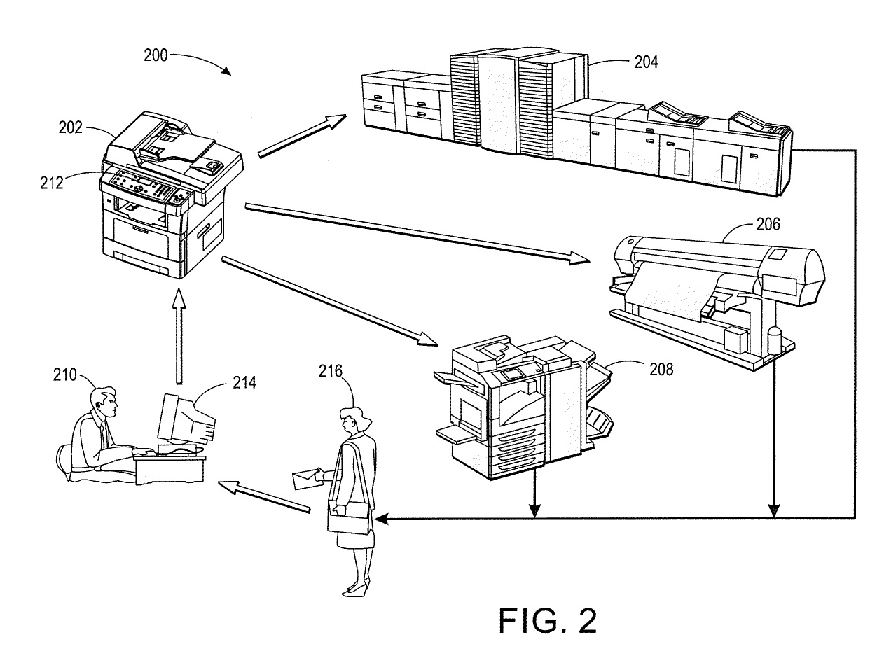

FIG. 2 is an example operating environment 200 of the disclosed virtual printing and print preview software. The virtual printing and print preview software is installed on the user's printer 202, in this example. The user's printer 202 is electronically connected to several other printers, including a high volume printer 204, a wide format printer 206, and a MFP 208. A user 210 interacts with the user printer 202 via a user interface 212 physically located on or near the user printer 202 or through a user computer 214. Both the user printer 202 and the user computer 214 have access to the virtual printing and print preview software. The user 210 can create a special print job for printing on any one of the remotely connected printers 204, 206, and 208. In the example shown in FIG. 2, the user 210 also can have the special print job delivered, such as by courier 216 or any other suitable delivery means.

In another example, the user's printer or printer driver is not actually directly connected to the remote printers on which the specialty print job is printed. Rather, the user's printer or printer driver is connected to a view of the capabilities of the remote printers that show the size, color options, quality modes, and other functionality of the remote printers. The user can then view the available printing capabilities of the printers as a conduit for ordering specialty print jobs. The user may or may not know the specific remote printing device used to print the specialty print job, but can view all printing capabilities from the user's printer or printer driver and can preview the basic quality, size, costs, and other features of printing the specialty print job on the remote printer.

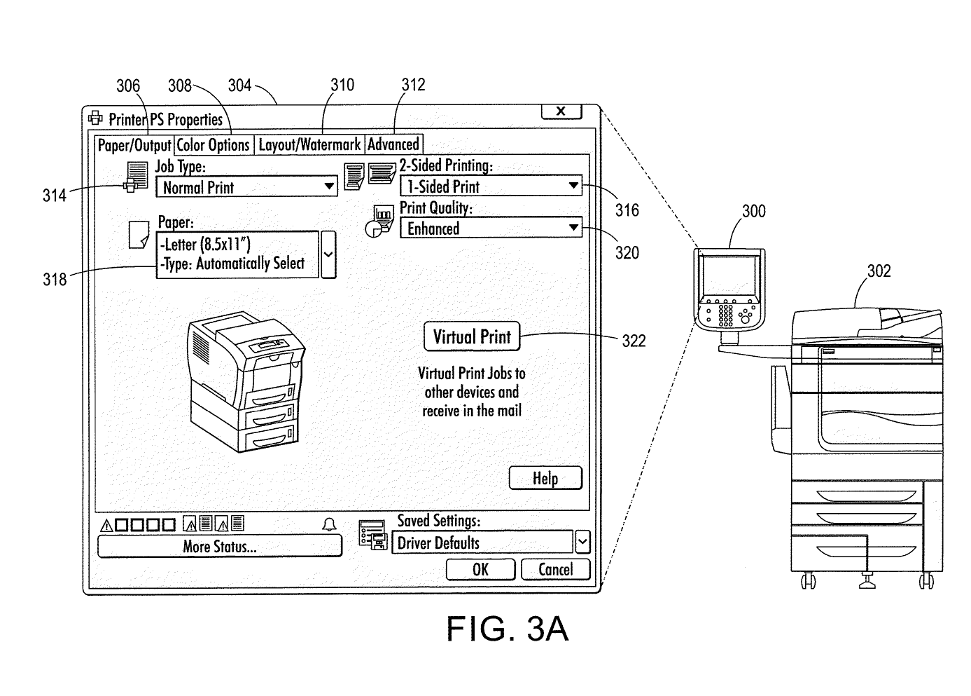

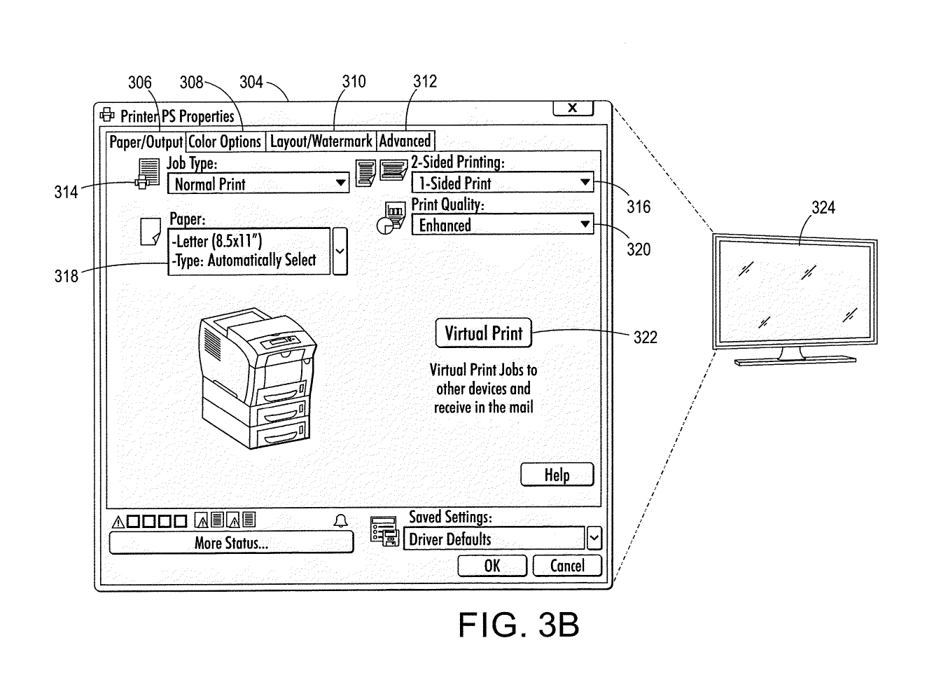

FIGS. 3-6b are various example screen images of virtual printing and print preview software. The order of these screen images may be rearranged without deviating from the nature of the disclosure. One or more of these steps may also be omitted in some examples of the disclosed software. Any variations, combinations, or sub-combinations of the disclosed screen images can be used.

FIG. 3A is an example screen image of a touch screen display 300 of the printer driver on the user's printer 302. The printer properties screen 304 shown in FIG. 3A displays common printer features for the user's printer 302 like paper/output 306, color options 308, layout/watermark 310, and advanced settings 312. On the paper/output 306 tab, the user is able to select various output qualities including the job type 314, 2-sided printing 316, the paper type 318, and the print quality 320. Also, on the paper/output 306 tab is the option for the user to select virtual print 322. The virtual print 322 option allows the user to access any other remote printer to which the user's printer 302 is connected. FIG. 3B also is an example screen image of the printer driver, but the output device is the user's computer and the printer driver is shown on the user's monitor 324 that is connected to the user's computer (or the screen image is displayed on any other display connected to the user's computer). The output device can also be any other suitable display, such as a user's smart television (TV), tablet, smartphone, or the like.

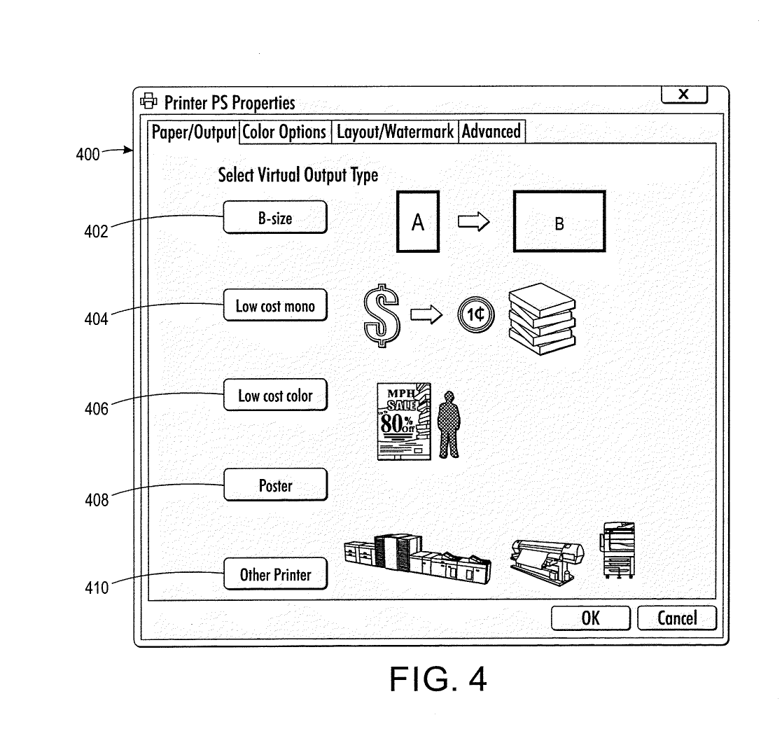

FIG. 4 shows a screen image of various printing output types 400 within the virtual print option. The virtual print option can include any number of different possibilities and output which are known to those skilled in the art. The example shown in FIG. 4 includes b-size printing 402, volume printing 404, specialty color printing 406, poster size printing 408, and other printers on which to print the specialty print job 410. The virtual print option types are available to the user to customize the specialty print job. For example, the user may wish to print a b-size specialty job and can select the b-size print type 402. The user can also select the low cost mono printing type selection 404 and the low cost color printing type selection 406 if the user has needs to print either a large quantity or a specialty color print job, respectively. The poster print type 408 allows a user to print the specialty job on a poster. The printer driver software guides the user through the specialty print job successfully based on the user's print job needs.

The user also can manually select a printer on which to print the specialty print job 410 if the user already knows the remote printer on which to print the specialty print job. The manual printer selection 410 can display to the user all of the available remote printers to which the user can print the specialty print job.

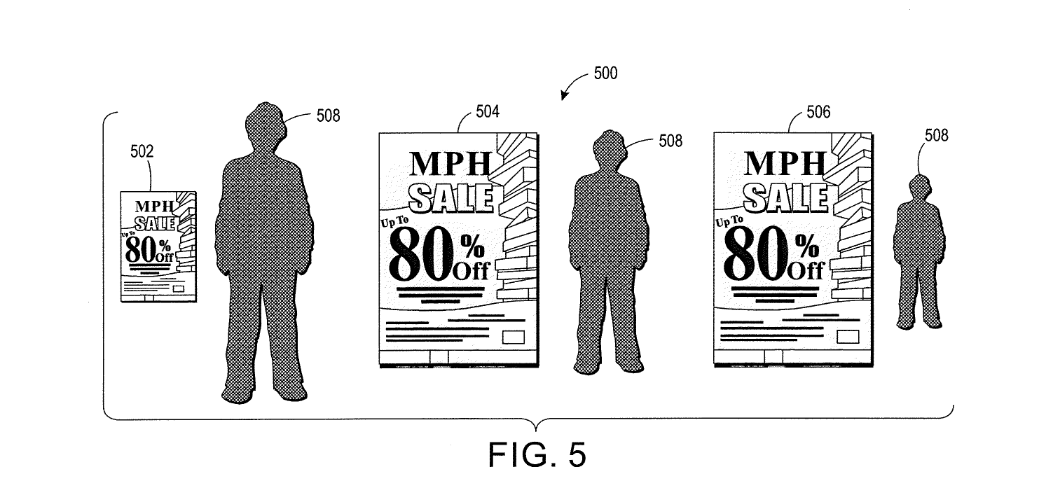

FIG. 5 is an example of the poster print type 500 selected by the user. The poster print type 500 illustrates for the user three different sized posters—the small poster 502, the medium poster 504, and the large poster 506. The poster print type 500 also can provide a size guide for the user to select the desired poster size. In the example shown in FIG. 5, the size guide is an image of a silhouette of an average sized person 508 positioned next to each of the poster size selections 502, 504, 506. The poster size selections 502, 504, 506 are seen relative to the size of the silhouette of an average sized person 508. The poster print type 500 provides the user with a visual indication of the size of the final poster print out relative to an average sized person.

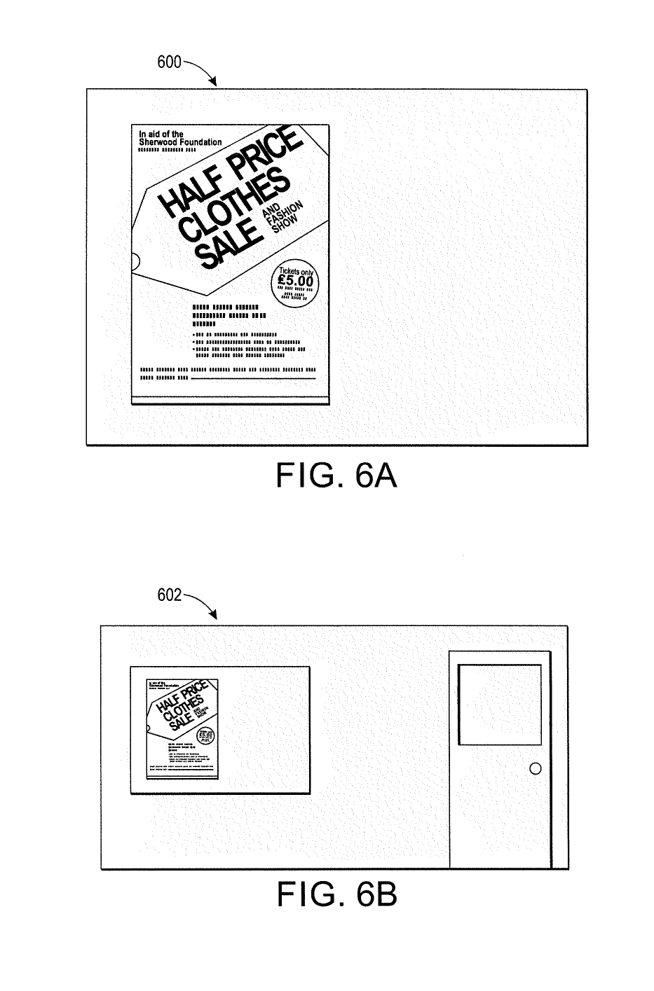

FIGS. 6a and 6b show example print preview screen images that a user see on the display or screen of the input printing device. FIG. 6a shows a sample of a custom print job and how it will look when it prints on the final output printer 600. FIG. 6b shows the sample custom print job's size as compared to a standard-sized door 602.

It will be appreciated that variations of the above-disclosed virtual printing and print preview systems and methods and other features and functions, or alternatives thereof, may be desirably combined into many other different systems, methods, or applications. Also various presently unforeseen or unanticipated alternatives, modifications, variations, or improvements therein may be subsequently made by those skilled in the art.

1. A printing method, comprising:
receiving printing selection data from a user at an input element of an input printing device, the printing selection data including a printing selection selected by the user from a plurality of printing selections;
identifying at least one output printing device that is remote from the input printing device, the at least one output printing device based on the printing selection data; and
transmitting a data message that includes the printing selection to the output printing device.

2. The printing method of claim 1, further comprising:
displaying the at least one output printing device on an output element of the input printing device; and
receiving a printing device selection from the user at the input element of the input printing device, the printing device selection based on the at least one output printing device.

3. The printing method of claim 1, wherein the input printing device and the output printing device have at least one different printing capability.

4. The printing method of claim 3, wherein the printing selection requires the at least one different printing capability.

5. The printing method of claim 4, wherein the printing capability includes at least one of the user's selected size of printing media, quality of printing, color of printing, quantity of printed items.

6. The printing method of claim 1, further comprising displaying a preview of a proof of the printing selection on a screen of the input printing device.

7. The printing method of claim 6, further comprising displaying the preview of the proof in multiple size options.

8. The printing method of claim 6, further comprising printing the preview of the proof on the input printing device.

9. The printing method of claim 6, further comprising receiving a user request to customize at least one feature of the proof.

10. The printing method of claim 6, wherein the proof includes a simulation of the printing selection on the output printing device including at least one output quality.

11. The printing method of claim 9, wherein the at least one output quality includes margins, color, quality of print, and size.

12. The printing method of claim 1, further comprising prompting the user to select a payment method for the printing selection.

13. The printing method of claim 1, further comprising prompting the user to select a delivery method for the printing selection.

14. The printing method of claim 1, further comprising storing the printing selection in an electronic shopping cart.

15. The printing method of claim 1, further comprising automatically linking the printing selection with another existing printing selection.

16. A printing method, comprising:
receiving printing selection data from a user at an input element of an input printing device, the printing selection data including a printing selection selected by the user from a plurality of printing selections;
determining whether the input printing device is capable of printing the printing selection;
if the input printing device is capable of printing the printing selection, further determining a cost efficiency of printing the printing selection on the input printing device;
comparing the cost efficiency of printing the printing selection on the input printing device with a cost efficiency of printing the printing selection on one or more of a plurality of remote printing devices;
if the input printing device is not capable of printing the printing selection, determining at least one of the remote printing devices that is capable of printing the printing selection;
receiving user selection data from the user at the input element, the user selection data including a user selection of the remote printing device for printing the printing selection;
generating and displaying to the user a preview of a proof of the printing selection; and
transmitting a data message that includes the printing selection to the selected remote printing device.

17. A printing system, comprising:
a user input element coupled to an input printing device and configured to receive printing selection data from a user;
a memory configured to store the printing selection data;
a processor coupled to the memory and allowing access to the printing selection data, the processor configured to:
determine whether the input printing device is capable of printing the printing selection;
identify at least one remote printing device that is configured to print the printing selection;
generate a preview of a proof of the printing selection on the at least one remote printing device; and
transmit a data message that includes the printing selection to the selected remote printing device; and
a display coupled to the input printing device and configured to display at least one of the printing selection data, the preview of the proof, and the remote printing device options.

18. The printing system of claim 14, wherein the input printing device and the at least one remote printing device have at least one different printing capability.

19. The printing system of claim 15, wherein the printing selection requires the at least one different printing capability.

20. The printing system of claim 16, wherein the printing capability includes at least one of the user's selected size of printing media, quality of printing, color of printing, quantity of printed items.

21. The printing system of claim 14, wherein the processor is further configured to receive a user request to customize at least one feature of the proof.

22. The printing system of claim 14, wherein the proof includes a simulation of the printing selection on the output printing device including at least one output quality

23. The printing system of claim 14, wherein the processor is further configured to prompt the user to select a payment method for the printing selection.

24. The printing system of claim 14, wherein the processor is further configured to prompt the user to select a delivery method for the printing selection.

25. The printing system of claim 14, wherein the processor is further configured to generate multiple size options for the preview of the proof and the display is further configured to display the multiple size options.
